(19) United States
(12) Patent Application Publication
(10) Pub. No.: US 2026/0309446 A1
(43) Pub. Date: Oct. 8, 2026

(54) MODULAR, MULTI-AXIS, SENSOR SYSTEM

(71) Applicant: Holistictlc Corporation, Bradenton, FL (US)

(72) Inventors: Chunyang Jiang, Bradenton, FL (US); Gui Li, Bradenton, FL (US)

(73) Assignee: Holistictlc Coporation, Bradenton, FL (US)

(21) Appl. No.: 19/171,302

(22) Filed: Apr. 6, 2025

(51) Int. Cl. F41A 23/10; F41A 23/04; F41A 23/12; F41G 3/00; G01C 21/16; G01C 25/00

(52) U.S. Cl. CPC F41A 23/10; F41A 23/12; F41G 3/00; G01C 21/16; G01C 25/005; F41A 23/04

(57) ABSTRACT

Many variables contribute to shooting inaccuracies. Even when a scope is perfectly positioned and stabilized, and the scope-mounted firearm is securely mounted on a supporting structure, tiny perturbations in orientation and stability can seriously degrade the accuracy of a shot, particularly at long distances. By securely mounting an IMU-based system on a firearm or firearm support structure, one has the ability to precisely measure pre-shot orientation and micro-movements; in-shot orientations and micro-movements; and post-shot orientations and micro-movements. The combination of data from pre-, in- and post-shot orientation and micro-movement detection can be used to reduce such perturbations and markedly improve shooting accuracy.

### TECHNICAL FIELD

The invention is a sensor system for enhanced stability, analysis and performance for shooting applications.

### BACKGROUND OF INVENTION

The longer the distance a bullet has to travel when it exits a rifle barrel until it strikes a target, the more chance for where the bullet was sited and where it actually hits to be significantly displaced. There are many things that factor into that displacement. Wind, humidity, air temperature will affect trajectory. So, too, will any misalignment in a scope's mounting that has not been compensated for during practice firing and zeroing. But, even if everything is precisely aligned, and atmospheric factors have been allowed for, any micro-movement just prior to, and at firing, can significantly affect displacement, especially as the distance is extended. Micro-movements are very subtle shifts in cant, pitch or yaw just prior to, and during firing. Without a means of precisely measuring such micro-movements, attempts to correct for them are often hit or miss.

### BRIEF DESCRIPTION OF THE INVENTION

The invention herein disclosed is a system comprising an inertial measurement unit (IMU) capable of detecting micro-movements just prior to, and at the time of triggering a shot. Inertial measurement makes use of multi-axis accelerometer and gyroscope subsystems contained within a unit that can be mounted on a monopod or tripod support upon which a rifle is securely mounted. It can also be built into a bipod support with the sensor subsystem tightly coupled to bipod structures such as extendable, lockable legs.

The securely mounted modular system, or built-in modular system, will precisely measure the stability of the rifle and its supporting structure, and measure any subtle changes to the cant, pitch and yaw of the mounted rifle just prior to, at the time of a shot, and shortly after.

The data provided by the sensors correlated to pre-shot, in-shot and post-shot timings can then be processed to clearly show changes in stability and micro-movements throughout the pre-shot, at-shot, and post-shot duration.

Using audible sound, of different frequencies, the sounds can be identified as cant, tilt and yaw signals. The shooter, without having to remove his eye from the scope can compensate for orientation discrepancies in real time. Once a shot has been taken, the system has captured orientations and micro-movements at pre-, at-, and post-shot times enabling the system's processor to reconstruct the succession of orientations and micro-movements.

As shot histories are aggregated, a machine-learning model subsystem is able to adjust the model to more accurately guide a shooter so as to improve shot accuracy results.

In addition, the system makes use of wireless communications and application program interface (APIs) to integrate with external systems where the system's results can be included to provide more insight, or where additional data can be factored into settings and analysis done by the system.

The system embodiment can comprise internal power sourcing, or external power sourcing. The system's containment structure can be augmented to provide mounting to popular monopod or tripod supports, and another embodiment has the system built into a bipod support.

### BRIEF DESCRIPTION OF DRAWINGS

FIG. 1 depicts an embodiment of the system mounted on a tripod supporting a rifle and scope.

FIG. 2 shows the micro-movement axes for cant, pitch and yaw.

FIG. 3 shows another system embodiment wherein it is built into and integrated with a bipod support structure.

FIG. 4 shows an embodiment of the system and its integration with external systems.

FIG. 5 shows an embodiment of the system in exploded view.

FIG. 6 shows an embodiment of method of use.

### DETAILED DESCRIPTION OF INVENTION

The greater the distance a bullet must travel between end of rifle barrel and intended target, the greater the potential displacement from the target to where the bullet actually hits. Many factors influence that displacement, but even where external factors have been compensated for, a shooter's orientation and micro-movements just prior to taking the shot, taking the shot, and immediately after will contribute to that displacement.

Among the existing systems for stability monitoring and ballistic computation are: fixed-axis electronic levels, standalone ballistic computers, optical stabilizers, and basic-motion analysis tools. Each, however, has its shortcomings. For example, fixed-axis electronic levels do not provide real-time corrections or multi-axis tracking. Instead, it requires manual checking by the shooter diverting attention from the target. Standalone ballistic computers lack shooter stability assessment and continuous monitoring. Optical stabilizers compensate for scope movement but do not assess firearm movement, orientation, or support-structure stability. Finally, basic-motion analysis tools provide limited post-shot feedback without pre-shot or in-shot stability tracking, preventing real-time corrections during critical shooting phases.

Existing solutions fail to provide an integrated approach that combines multi-axis motion detection with shooter-specific pattern analysis. Current systems cannot simultaneously track stability across different shooting phases (pre-shot, in-shot, post-shot) while providing adaptive feedback and stability correction guidance.

The invention herein disclosed comprises a multi-axis IMU-based system that is operative to precisely monitor real-time shooter stability across multiple axes that includes cant, pitch, yaw and micro-movements.

One embodiment of the multi-axis IMU-based system enables mounting to standardized monopod and tripod support structures. Changing from one type mount to a different one requires no tools and the system quickly compensates its sensing and processing to the current support structure to which it is mounted. Power management can accommodate built-in battery power or external power sourcing.

A second embodiment of the system has the multi-axis IMU-based system built into a bipod support structure. Here, the sensors and processing may be tightly coupled to the bipod's structures and functions.

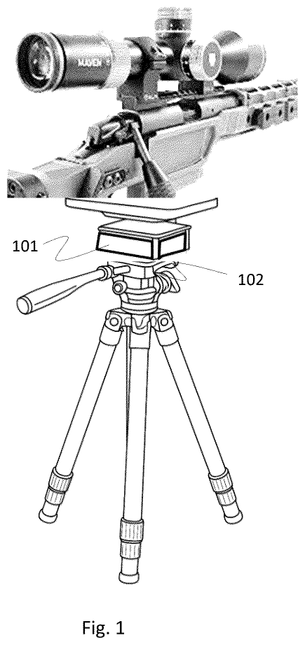

As shown in FIG. 1, the IMU-based system (101) is mounted on a tripod (102).

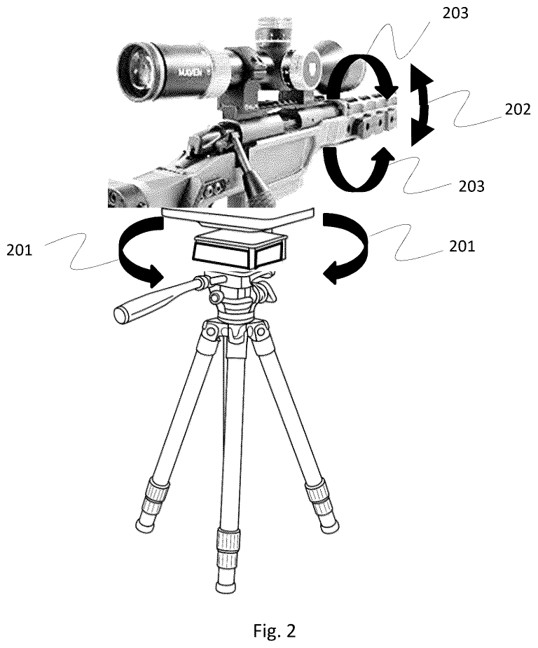

As shown in FIG. 2, as mounted, the IMU-based system is operative to detect any rotation in an essentially horizontal plane (201), called “yaw.” Any change in rotation in a plane parallel to the rifle's barrel (202), called “pitch,” and any change in rotation of the rifle in a plane perpendicular to its barrel (203l, called “cant.” Any orientation error in yaw can cause horizontal displacement, later. Any orientation error in pitch can cause vertical displacement, later. And, any orientation error in cant can effect displacement that is both horizontal and vertical.

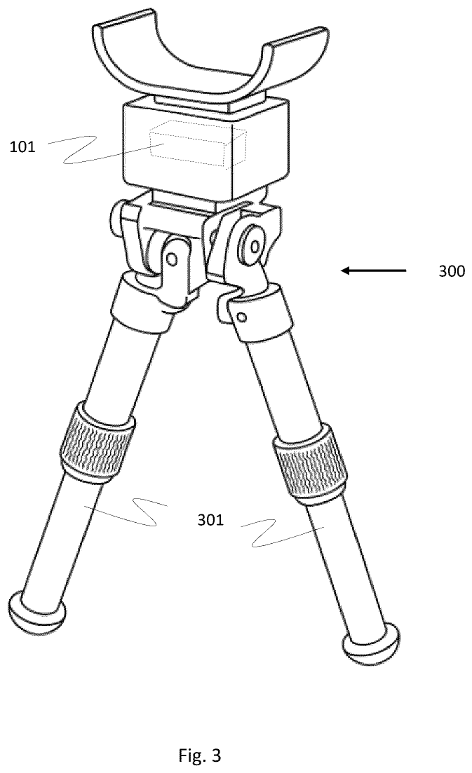

As shown in FIG. 3, the multi-axis IMU system (101) is built into and integrated with the structures of a bipod support structure (300). For example, the extendable, lockable extension legs are tightly coupled to the IMU system and automatically adjusted for during operation.

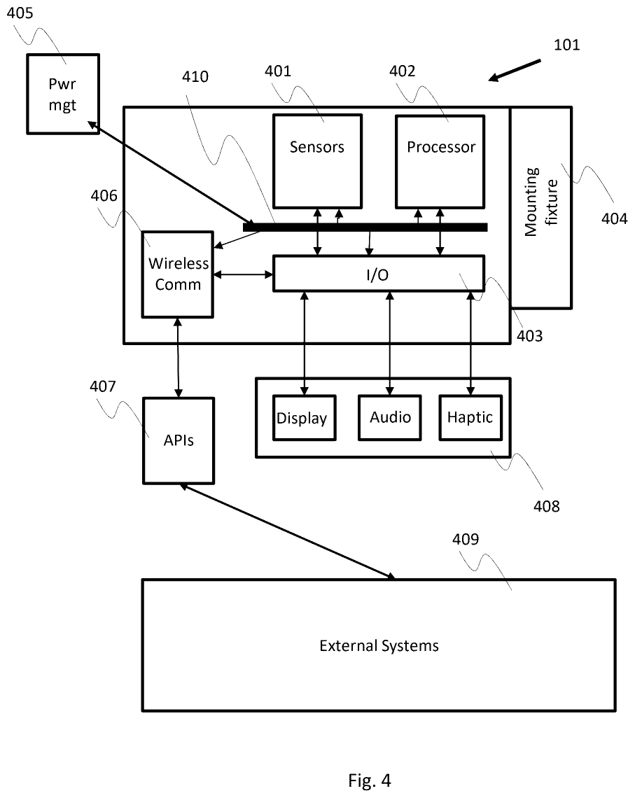

As shown in FIG. 4, an embodiment of the IMU-based system (101) comprises a sensor subsystem (401), a processor subsystem (402), an input-output (I/O) subsystem (403), a mounting fixture (404), a power-management subsystem (405), a wireless communication subsystem (406), application program interface (API) subsystem (407), a sensory feedback subsystem (408), external systems (409), and a power bus (410). The sensor subsystem comprises an accelerometer and gyroscope subsystem. The accelerometer is operative to detect linear acceleration and gravitation forces. The gyroscope is operative to measure angular velocity and rotation. The processor subsystem comprises a microcomputer subsystem, read-only program memory, and read/write data memory, At least one control program is stored and a machine-learning model is stored. The I/O subsystem provides an interface between sensor subsystem. processor subsystem, wireless communication subsystem, and sensory feedback subsystem.

The external systems comprise applications operative to provide stability data, environmental data, user-interface and control data, training data, and distance data.

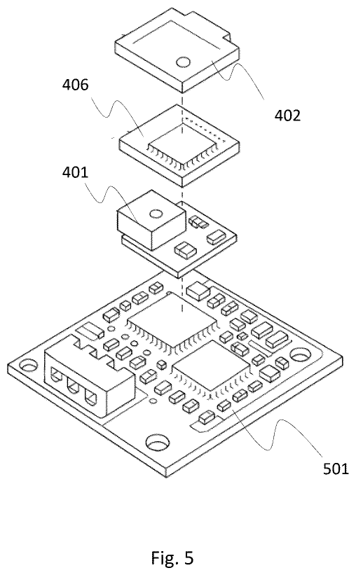

FIG. 5 is an embodiment of the IMU-based system showing its modularity and compactness. It comprises the printed-circuit board and I/O components (501), the accelerometer and gyroscope sensor subsystem (401), the processor subsystem (402) and a wireless communication subsystem (406).

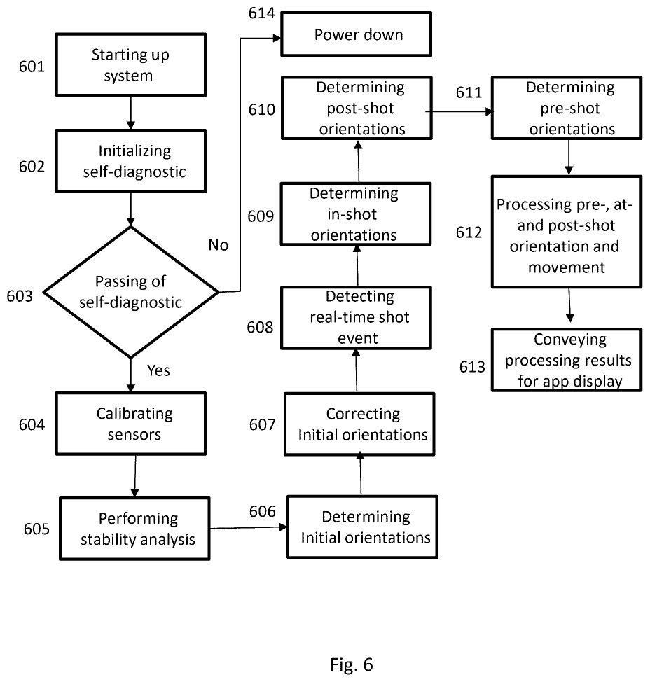

FIG. 6 is an embodiment of method steps using the IMU-based system. Once mounted, or built in and integrated with a bipod support structure, the system is started up (601) and initializes a self-diagnostic process to determine that all subsystems are operating properly (602). If it is determined that the subsystems are operating properly (603), a sensor calibration step is invoked (604). If one or more subsystems are not operating properly, the system powers down (614). Once the calibration step concludes, the system performs a stability analysis (605). Then, the system determines orientation (606). It then compares current orientation with predetermined orientations and corrects for differences using one or more sensory feedback signals (607). When the shooter deploys the trigger, the IMU-based system detects that in-shot event monitoring orientation and micro-movements (608 and 609). Shortly after the shot is taken, the system detects orientation and micro-movements (610). Because the system was continuously monitoring orientation prior to the in-shot event, the system is able to capture the pre-shot orientation and micro-movements (611). The processing subsystem now uses the pre-, in- and post-shot orientation and micro-movement data captured to prepare a composite, duration view (612). The processing results are then conveyed to integrated external system applications (613).

The sensor ranges providing minimal essential accuracies are +/−2 to +/−16 grams for the accelerometer; and +/−250°/sec to +/−2000°/sec for the gyroscope. The calibration mode provides +/−1° accuracy. To accommodate a variety of skill levels, the systems orientation threshold settings are adjustable for cant (0.1-3.0°), pitch (0.1-5.0°) and yaw (0.1-5.0°).

The machine-learning-based analysis model recognized stability patterns based on previous shooting sessions using a neural network. In addition, it can generate predictive shooter recommendations based on this historical data. And, it can optimize sensitivity thresholds based on terrain, environmental conditions, and shooter preferences.

The drawings and descriptions are for exemplary embodiments and should not be read as limiting the scope of the claims.

What is claimed is:

1. A system comprising:
a sensor subsystem;
a processor subsystem;
an I/O subsystem;
a wireless communication subsystem;
a power-management subsystem;
an encasement subsystem;
a mounting fixture; and
an external sensory feedback subsystem.

2. A system comprising:
the sensor subsystem;
the processor subsystem;
the I/O subsystem;
the wireless communication subsystem;
the power management subsystem;
an encasement subsystem;
a bipod support structure; and
the external sensory feedback subsystem.

3. The system as in claim 1 wherein the sensor subsystem comprises:
an accelerometer subsystem: and
a gyroscope subsystem.

4. The system as in claim 2 wherein the sensor subsystem comprises:
the accelerometer subsystem; and
the gyroscope subsystem.

5. The system as in claim 1 wherein the processor subsystem comprises:
a microcontroller;
read-only, control-program memory;
read/write data memory, at least one control program; and
a machine-learning model hosted on a neural network.

6. The system as in claim 2 wherein the processor subsystem comprises:
The microcontroller;
The read-only, control-program memory;
The read/write data memory,
The at least one control program; and
the machine-learning model hosted on a neural network.

7. The system as in claim 1 wherein the I/O subsystem is operative to integrate the sensor subsystem, the processor subsystem, the wireless communication subsystem and the external sensory feedback system.

8. The system as in claim 2 wherein the I/O subsystem is operative to integrate the sensor subsystem, the processor subsystem, the wireless communication subsystem and the external sensory feedback system.

9. The system as in claim 1 wherein the wireless communication subsystem is operative to convey data between the processor subsystem, the external sensory feedback system and integrated external systems.

10. The system as in claim 2 wherein the wireless communication subsystem is operative to convey data between the processor subsystem, the external sensory feedback system and integrated external systems.

11. The system as in claim 1 wherein the power-management subsystem is operative to provide operational power to the sensor subsystem, the processor subsystem, the I/O subsystem, the wireless communications subsystem and the external sensory feedback subsystem.

12. The system as in claim 2 wherein the power-management subsystem is operative to provide operational power to the sensor subsystem, the processor subsystem, the I/O subsystem, the wireless communications subsystem and the external sensory feedback subsystem.

13. The system as in claim 1 wherein the encasement subsystem encases the sensor subsystem, the processor subsystem, the I/O subsystem, and the wireless communications subsystem.

14. The system as in claim 2 wherein the encasement subsystem encases the sensor subsystem, the processor subsystem, the I/O subsystem, and the wireless communications subsystem.

15. The system as in claim 1 wherein the encasement subsystem is operative to securely mount on a standard monopod tripod supporting structure for supporting a firearm.

16. The system as in claim 1 wherein the encasement subsystem is operative to securely mount on a standard tripod supporting structure for supporting a firearm.

17. The system as in claim 2 wherein the encasement subsystem is built into and integrated with structures of a standard bipod supporting structure for supporting a firearm.

18. The system as in claim 1 wherein the external sensory feedback subsystem comprises:
a visible display;
an audible transducer; and
a haptic transducer.

19. The system as in claim 2 wherein the external sensory feedback subsystem comprises:
the visible display;
the audible transducer; and
the haptic transducer.

20. A method comprising:
starting up an IMU-based system;
performing a self-diagnostic routine on the IMU-based system;
powering down the IMU-based system if the self-diagnostic routine shows any subsystem not working properly;
continuing with calibrating an accelerometer and gyroscope sensor if self-diagnostic shows proper operation of all subsystems;
performing stability analysis;
determining initial orientation;
correcting initial orientation by adjusting yaw, pitch and cant orientation;
monitoring orientation and micro-movements at instant of shoot being fired;
monitoring orientation and micro-movement just post-shot;
determining orientation and micro-movements at a predetermined time pre-shot;
processing pre-, in- and post-shot orientations and micro-movements and aggregating; and
conveying processing results to integrated external system applications.
